(19) United States
(12) Patent Application Publication
(10) Pub. No.: US 2009/0018819 A1
(43) Pub. Date: Jan. 15, 2009

(54) TRACKING CHANGES IN STRATIFIED DATA-STREAMS

(75) Inventors: Jeremy Wright, Berkeley Heights, NJ (US); Alicia Abella, Morristown, NJ (US)

Correspondence Address: AT&T CORP., ROOM 2A207, ONE AT&T WAY, BEDMINSTER, NJ, 07921, US

(73) Assignee: AT&T Corp., New York, NY (US)

(21) Appl. No.: 11/776,017

(22) Filed: Jul. 11, 2007

(51) Int. Cl. G06F 17/27

(52) U.S. Cl. 704/9

(57) ABSTRACT

Disclosed are systems, methods, and computer readable media for detecting and coordinating changes in stratified data streams. The method embodiment comprises receiving one or more data streams, each data stream comprising at least one lexical item and having at least one metavalue, detecting a change in a frequency of the at least one lexical item for each metavalue separately, coordinating the change in frequency of the at least one lexical item with changes in frequencies of lexical items associated with the at least one lexical item by grouping the at least one lexical item and the associated lexical items over time and across at least one metavalue, wherein end grouping is a coordinated change-event, and presenting a summarization of the coordinated change-event to a user.

### BACKGROUND OF THE INVENTION

1. Field of the Invention

The invention relates generally to identifying trends in a data set and more specifically to detecting and coordinating changes in stratified data streams.

2. Introduction

Organizations often collect voluminous corpora of data continuously over time. The data may be, for example, email messages, transcriptions of customer comments or of phone conversations, recordings of phone conversations, medical records, news-feeds, or the like. Analysts in an organization may wish to learn about the contents of the data and the changes that occur over time, including when and why, such that they may understand and/or act upon the information contained within the data. Because of the large volume of data, reading each document in the corpora of data individually to determine the changes and summarize the contents can be expensive as well as difficult or impossible. Conventional statistical tools can test a predetermined time interval for whether or not the frequency of a given lexical item has changed, but the time interval may not be fine enough to usefully detect particular data trends. Methods adopted from information retrieval for topic tracking have the same shortcoming. Accordingly, what is needed in the art is an improved way to dynamically facilitate the understanding of changes in large corpora of data.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be leamed by the practice of the invention as set forth herein.

The invention includes a network, a system, a method, and a computer-readable medium associated with tracking changes in stratified data streams. An exemplary method embodiment of the invention comprises receiving one or more data streams, each data stream comprising at least one lexical item and having at least one metavalue, detecting a change in a frequency of the at least one lexical item for each metavalue separately, coordinating the change in frequency of the at least one lexical item with changes in frequencies of lexical items associated with the at least one lexical item in the one or more data streams by grouping the at least one lexical item and the associated lexical items over time and across at least one metavalue, wherein end grouping is a coordinated change-event, and presenting a summarization of the coordinated change-event to a user.

The principles of the invention may be utilized to provide a user, for example, an efficient and effective summary of important changes in voluminous corpora of data in a format that is easy for the user to digest and analyze. In this manner, the user will be better suited to analyze and recognize important changes within the voluminous corpora of data that may need attention

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a basic system or computing device embodiment of the invention;

FIG. 2 illustrates an example implementation to detect and coordinate changes in data streams;

FIG. 3 illustrates an example of how changes in the frequency of multiple words are coordinated;

FIG. 4 illustrates an example of significant changes in frequencies of lexical items being coordinated over time and across metavalues when Hurricane Katrina hit the gulf coast;

FIG. 5 illustrates an example map that shows areas of interest for a given change-event;

FIG. 6 illustrates a chart of telephone traffic from a network operations center;

FIG. 7 illustrate an example presentation of a change-event to a user;

FIG. 8 illustrates a graph of the frequency of notes referring to “SBC” during the AT&T and SBC merger change-event;

FIG. 9 illustrates an example graphical user interface presenting the summarization of the AT&T and SBC merger change-event;

FIG. 10 illustrates an example of changes being tracked in a trouble-ticket creation system;

FIG. 11 illustrates the frequency of people calling to ask about their flight status during a blizzard;

FIG. 12 illustrates the tracked changes in people's calls during a blizzard;

FIG. 13 illustrates an example of a contemporary change-event; and

FIG. 14 illustrates a method embodiment of the system.

### DETAILED DESCRIPTION OF THE INVENTION

Various embodiments of the invention are discussed in detail below. White specific implementations are discussed, it should be understood that this is done for illustration purposes only. A person skilled in the relevant art will recognize that other components and configurations may be used without parting from the spirit and scope of the invention.

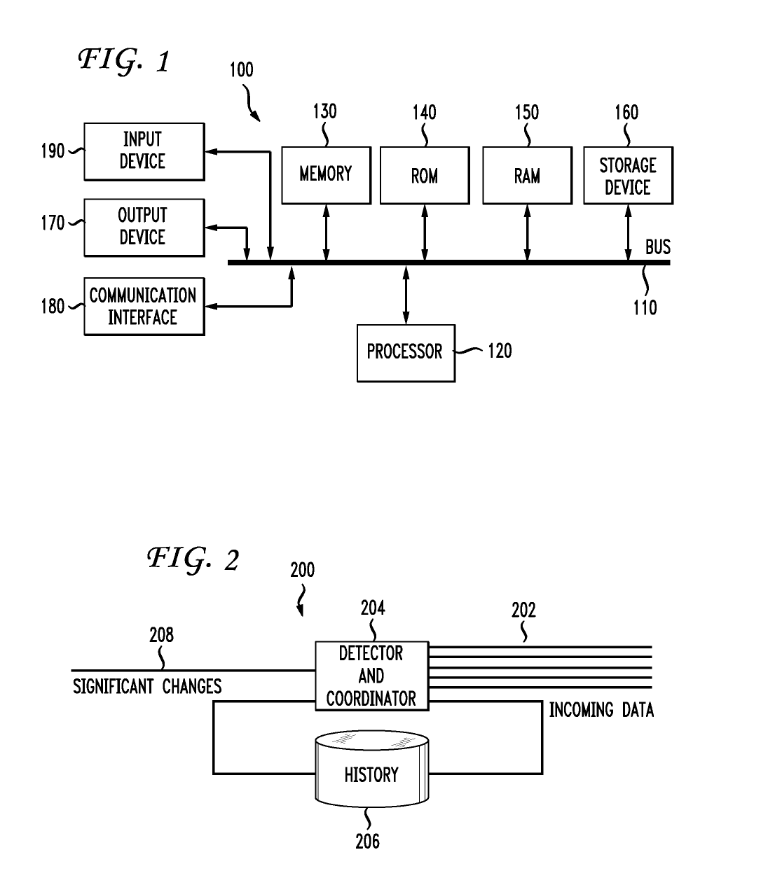

With reference to FIG. 1, an exemplar system for implementing the invention includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS), containing the basic routine that helps to transfer information between elements within the computing device 100, such as during start-up, is typically stored in ROM 140. The computing device 100 further includes storage means such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output means. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed. In some respects, the functionality associated with the invention will generally be described as being preferred by “the system” which may be any of a number of hardware configurations.

The present invention relates to detecting and coordinating changes within data streams. FIG. 2 illustrates an example implementation to detect and coordinate changes in data streams 200. In the example, the implementation involves receiving incoming data streams 202 from any number of sources. A summary of the current state and parameters are preserved in the history file 206 and are also serve as an input to the detector and coordinator. The detector and coordinator 204 use the new data from the data stream plus the history data in order to detect changes. However, the detector and coordinator have the ability to detect steps, trends, and cycles in the data. In one example embodiment, the detector and coordinator maximize the likelihood of the change being important and only output significant changes or output significant changes 208 first. In another example embodiment, the coordinator and detector prioritize the important changes and output changes in order of significance 208. However, significance can be defined in a number of ways. “Significance” usually means statistical significance, but events that are of most interest to an analyst are often not the most statistically significant ones. A more general measure which combines statistical significance with other factors such as information content gives an improved prioritization of events for presentation to an analyst. Information content measures the informativeness or novelty-value of a change, and prioritization of changes for presentation to an analyst is based upon both this measure and their statistical significance.

An aspect of the invention is that large numbers of lexical items are considered simultaneously. The incoming data streams consist of one or more lexical items. A lexical item can be a single or set of words, symbols, numbers, or other tokens. In order to manage the large amount of data, the present invention utilizes metavalues associated with the data. Metavalues comprise information about the incoming data. Examples of metavalues or metadata include geographic location, service plans used, interaction history, information about the source, current events outside the data itself but that may be occurring at the same time or location that is associated in some fashion with the data, or information about the content of the data such as the type of data the stream contains. The present invention detects a change in a frequency of lexical items for each metavalue separately. This can be accomplished by subdividing data streams into a set of smaller substreams based on the metadata. In this manner, it is much easier to detect changes that affect only those substreams. For instance, there are certain subsets of the population for whom various changes suddenly become very important, and by trying to detect these changes by simply using the latest data stream as a whole, then the rest of the data, which is unaffected, can mean a failure to detect that change in a timely manner. By looking at the metadata and detecting the changes for the separate substreams, a greater number of significant changes can be detected early on.

When detecting changes, the system can look at the relative frequency, the absolute frequency, or both. There are many possible factors to look at to determine the relative frequency of a word. If there is a great increase in the total number of lexical items, it is not always desirable to present changes to a user, partly because the total number of changes could be overwhelming. Therefore, in some circumstances looking at the relative frequency of a lexical item is preferred. The frequency of the at least one lexical item for which the change is being detected can be relative to the total number of lexical items or a context of the at least one lexical item. For instance, there might be an increase in the word “terminal,” but the analyst is only interested in the increase relative to the words “illness” or “sickness.” A change in the frequency of the lexical item “home” can be detected only when used in the context of “new home.” In other circumstances, looking at the absolute frequency could be preferred. For example, a Poisson rate model can be used to measure changes in absolute frequency with the significance of change-points measured using an F-test and interest of change-points using variance-stabilizing transformation for Poisson. Using relative frequency or absolute frequency can be decided automatically, in order to optimize results.

Furthermore, the system can detect steps, trends, and periodic cycles. For example, the lexical items, “summer” and “vacation” may increase in frequency during summer months. This periodic change in frequency can be detected and presented to a user. Steps and trends in the use of a lexical item may be important include in a summarization to an analyst. For instance, if the lexical item “flu” increased during winter months, but a trend began where “flu” doubled in frequency every winter from the previous winter, the trend can be detected and presented for analysis.

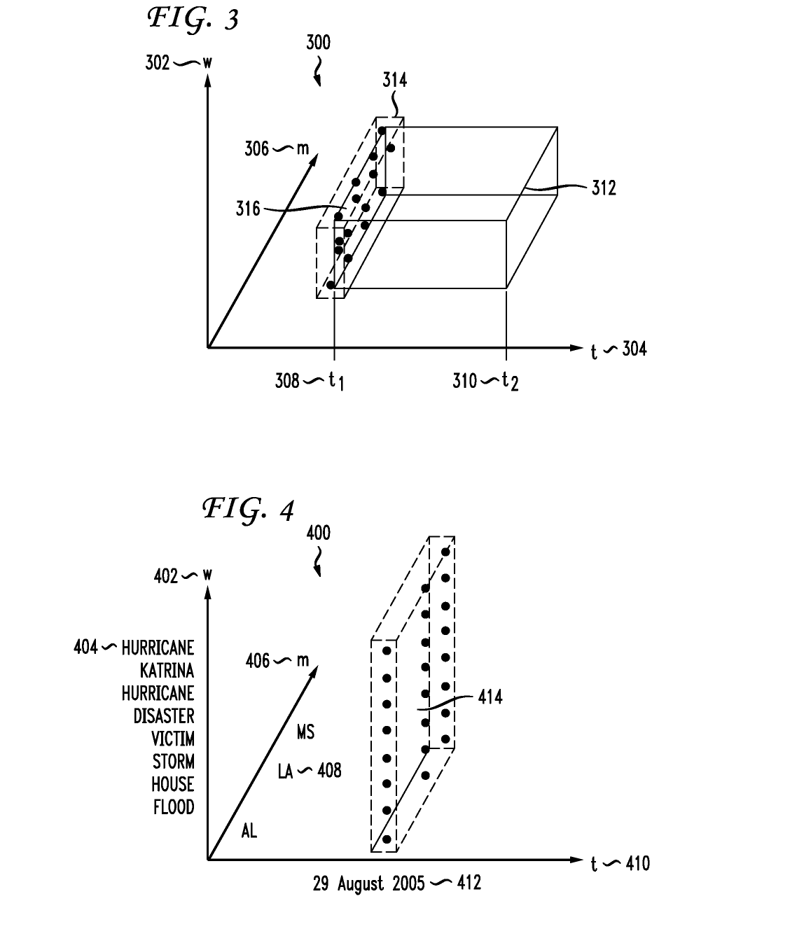

Another aspect of this disclosure is that the significant changes in frequencies of lexical items are coordinated over time and across metavalues. FIG. 3 illustrates an example of how the changes in frequency of words is coordinated 300. The solid box 312 represents a burst of activity for the subsets of words (w) 302 and metavalues (m) 306, between t₁ 308 and t₂ 310 on the time axis 304. In the example, for simplicity the words and metavalues are shown as contiguous, although they need not be. The dotted box 314 represents the onset of an event. The present invention optimizes the cluster of change-points 316 and groups the cluster into a change-event. For example, associated lexical items that change at about the same time are grouped together. Associations can be determined by a user or by looking at the meaning of the lexical items, associated metavalues with the lexical items, or any other method in order to optimize the cluster of change-points. The process can be repeated to find multiple change-events.

One aspect of the disclosure is that when trying to detect a change in frequency of a lexical item, the time intervals associated with the frequency of the lexical item can be selected automatically. Important changes may be occurring during short or long time intervals that may not be detected with preselected time intervals. For example, if an important change happens from one day to the next, but the detector is looking at the frequency on a month-to-month basis, it may not detect the important change. By looking back through time and for any changes that have occurred and when they occured, time intervals can be dynamically determined, improving detection techniques.

FIG. 4 shows an example of significant changes in frequencies of lexical items being coordinated over time and across metavalues when Hurricane Katrina hit the gulf coast 400. On Aug. 29, 2005, lots of people were calling or sending emails or other messages containing words 402 such as “Storm,” “Flood,” “Hurricane,” or irregular abbreviations such as “Hurrican” and so on 404. The change-points 414 for each of these lexical items happened about the same time 410 on or around August 29, 2005 412. By looking at the metavalues 406 associated with the data streams containing these lexical items, the areas of concern can be detected. In this example, the areas of concern are Mississippi, La., and to a lesser extent, Alabama 408. Both lexical items that were not being mentioned before, such as Katrina, and lexical items that were being used but simply became more frequent or used in a new context such as the use of the word “house” to indicate that a person is moving from their home can be detected as a significant change.

One aspect of the disclosure is that frequent subsequences can be used to create a summarization of the coordinated change-events. Because it can be hard to discern the meaning of a change-event just from the lexical items, it is desirable to present the change-event to a user in a manner that is easier to understand. One option would be to present all the documents that the lexical items are found in. However, the documents containing the lexical items may be numerous and bulky. A preferred embodiment would be finding phrases or subsequences of lexical items that would be more meaningful than the lexical items themselves. In some instances, longer phrases may not repeat the exact lexical items in the exact order, but approximate subsequences might be more common. Therefore, a compact summarization of each change-event can be created by searching for recurrent phrases or frequent subsequences of lexical items allowing for approximate matches.

Another aspect is that a summarization with three dimensions, time lexical vocabulary, and metavalues, can be presented to a user. Furthermore, the presentation can support drill-down capability. For example, after a change-event has been detected and coordinated, the lexical items in the change-event can be displayed along with any associated metavalues. The time dimension can be real-time, or a user can look at the date of the change. Drill-down capability allows the user to get more specific information about change-events and the time, lexical vocabulary, and metavalues associated with summarization. As an example, a user might know the time of the onset of a change-event and could drill-down to see the duration of the change-event. Another example would be a user selecting a lexical item in order to see frequent subsequences containing the lexical item. Also, a user could drill-down to see more specific regions, or information about a region where a change-event was taking place. The summarization can be presented on the internet, on a computing device, or in any other manner in order to optimize user experience.

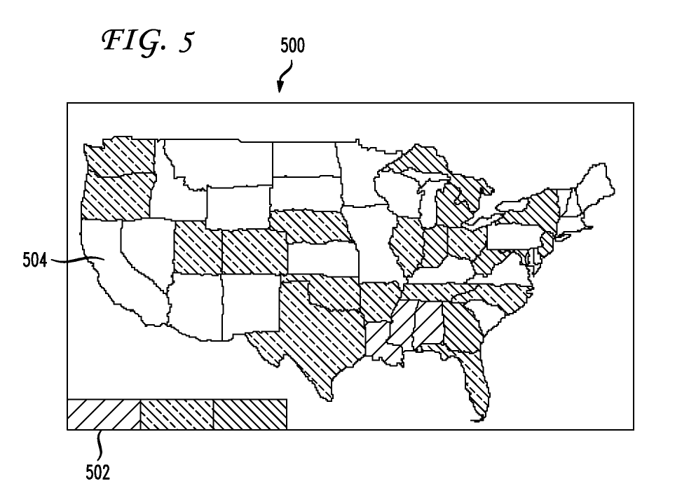

In one embodiment, the summarization can be presented via a graphical user interface that has a map which displays the location of any metavlaues corresponding to a geographic location. FIG. 5 illustrates an example map that shows areas of interest for a given change-event 500. Different shades, colors, or patterns 502 are used in order to differentiate between areas most affected by a change-event or different change-events. The affected regions are highlighted on the map 504. While the example here shows the United States, maps of different countries, states, provinces, counties, cities, or other geographic locations may also be used. By selecting a state, a user can view more information related to the change-event for that state. For instance, the user could select a state to view specific regions within the state affected by the change-event or details of the change-event specific to that state. Furthermore, the map does not have to be of a geographic location. For example for a metavalue corresponding to a calling plan, the graphical user interface could consist of an interactive display that told the user visually what calling plans are affected by the change and relates that to the lexical items.

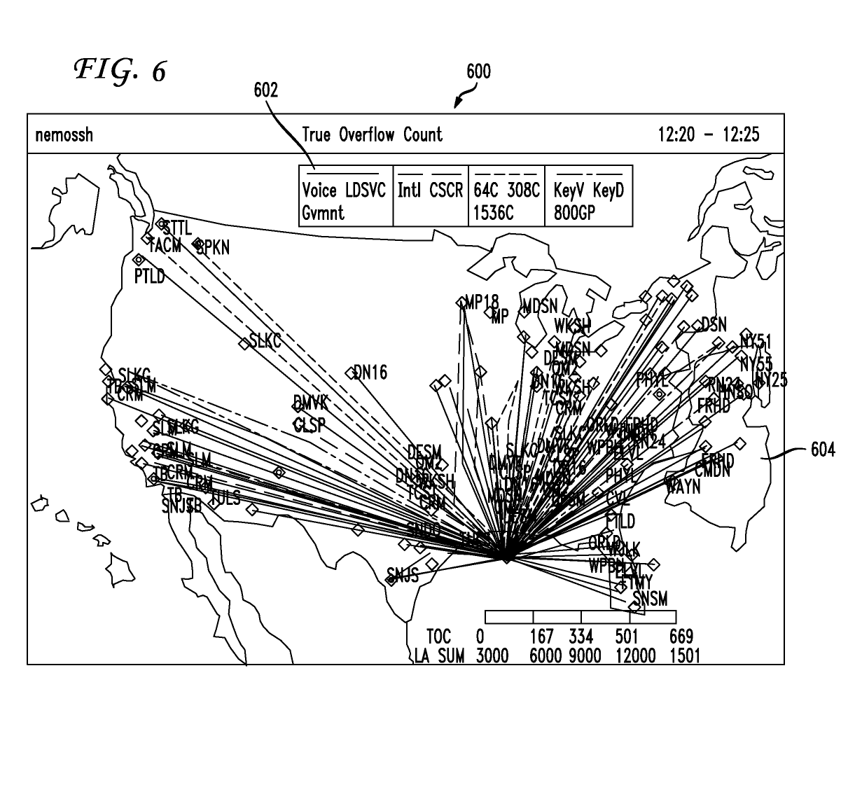

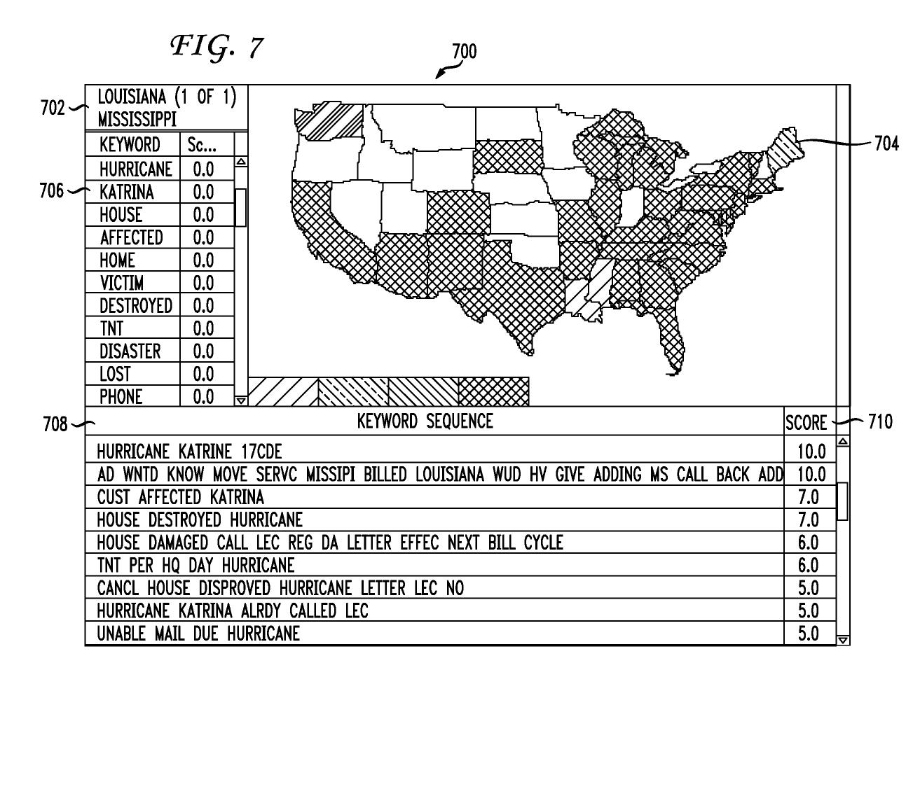

FIG. 6 and FIG. 7 illustrate an example change-event and the presentation of the detected and coordinated change-event. FIG. 6 shows a chart of telephone traffic 602 from a network operations center 600. The chart shows the excess telephone traffic that was generated on Aug. 29, 2005 from the region where Katrina hit 604. FIG. 7 illustrates an example presentation of this change-event to a user 700. A change in the frequency of various lexical items is detected from the excess telephone traffic and related changes are clustered together into a change-event. The lexical items associated with the change-event are displayed 706 along with the metavalues they are mapped across 702. Frequent subsequences found within the data streams are also displayed 708 along with a score indicating the relevance, number of times, or the frequency with which the subsequence was found 710. A graphical map 704 highlights the geographical location of the change-event. Different colors or patterns indicate separate but contemporary change-events. In this example Louisiana and Mississippi are the relevant areas of interest for the change-event that includes the lexical items “Hurricane,” “Katrina,” and so on. Louisiana and Mississippi are highlighted with the same pattern while other states are highlighted with different patterns, indicating different, contemporary change-events.

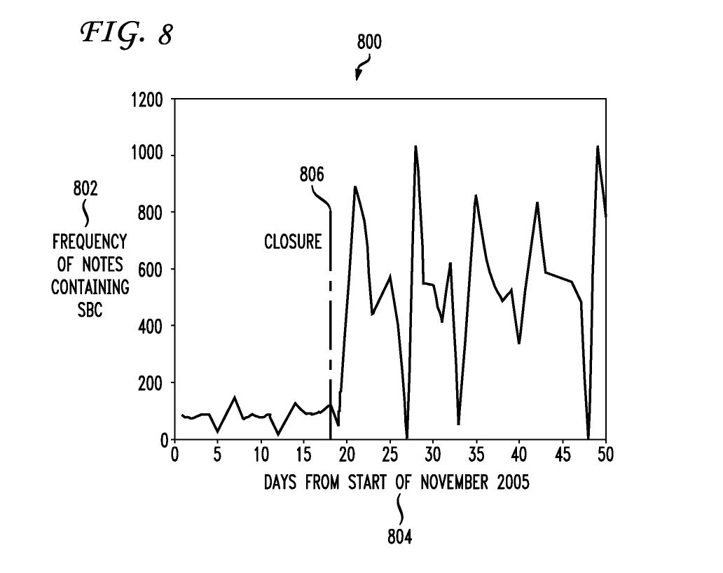

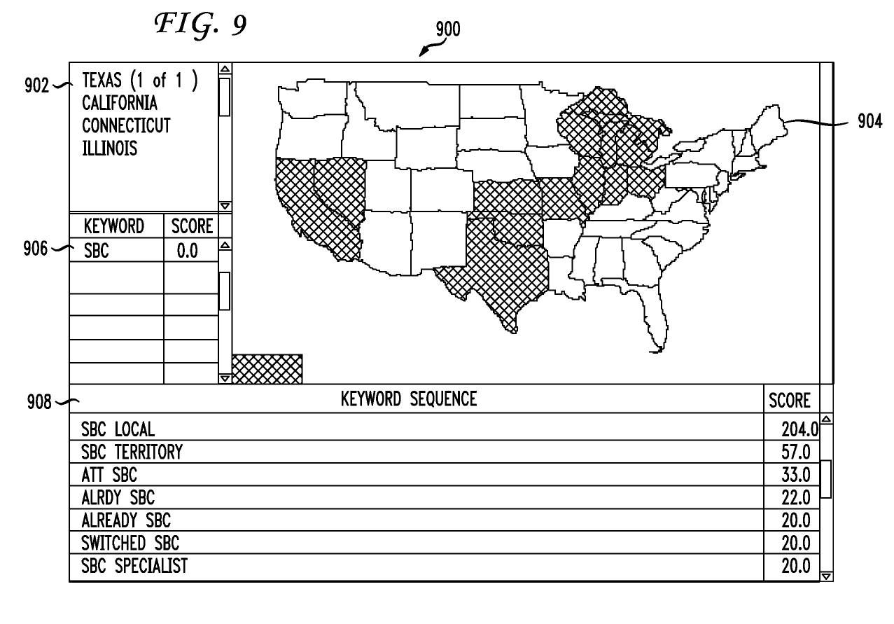

FIG. 8 and FIG. 9 illustrate example results from tracking changes in data streams during the AT&T and SBC merger. FIG. 8 is a graph illustrating the frequency of notes referring to “SBC” during November 2005 800. On Nov. 18, 2005, the frequency of notes referring to “SBC” greatly increased slightly after the merger of AT&T with SBC. FIG. 9 shows a graphical user interface presenting the summarization of the AT&T and SBC merger change-event. The areas of interest are listed 902 and highlighted on a geographic map 904. The lexical item, SBC, is the only one in this particular change-event 906. Frequent subsequences are presented in order to provide information about the context about the lexical item 908. The sequences in this case are shorter due to a lack of consistent focus in the data.

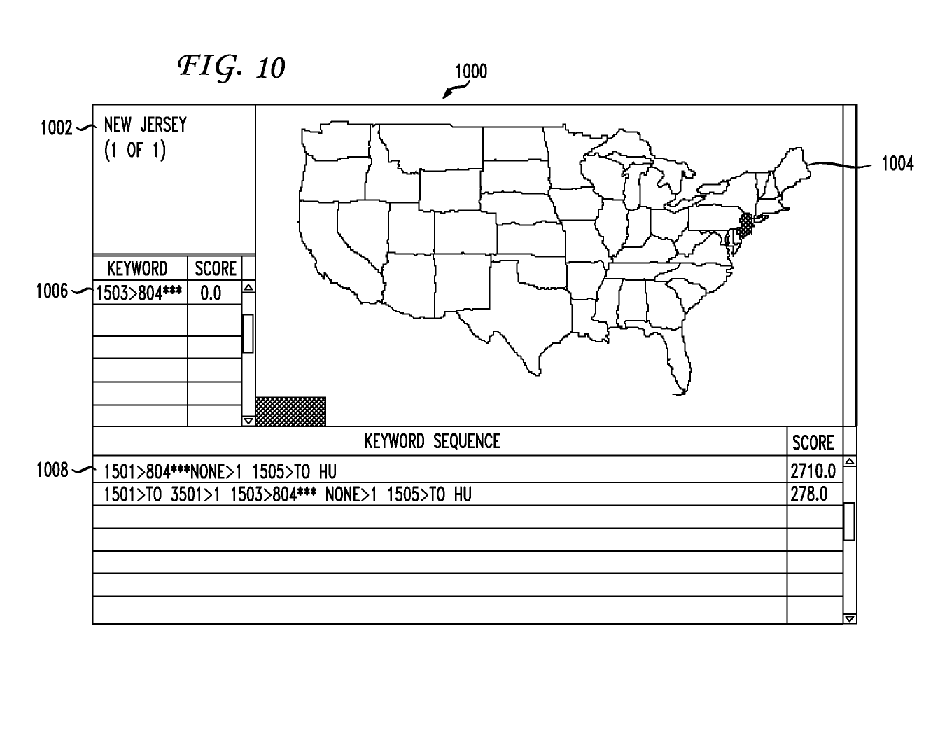

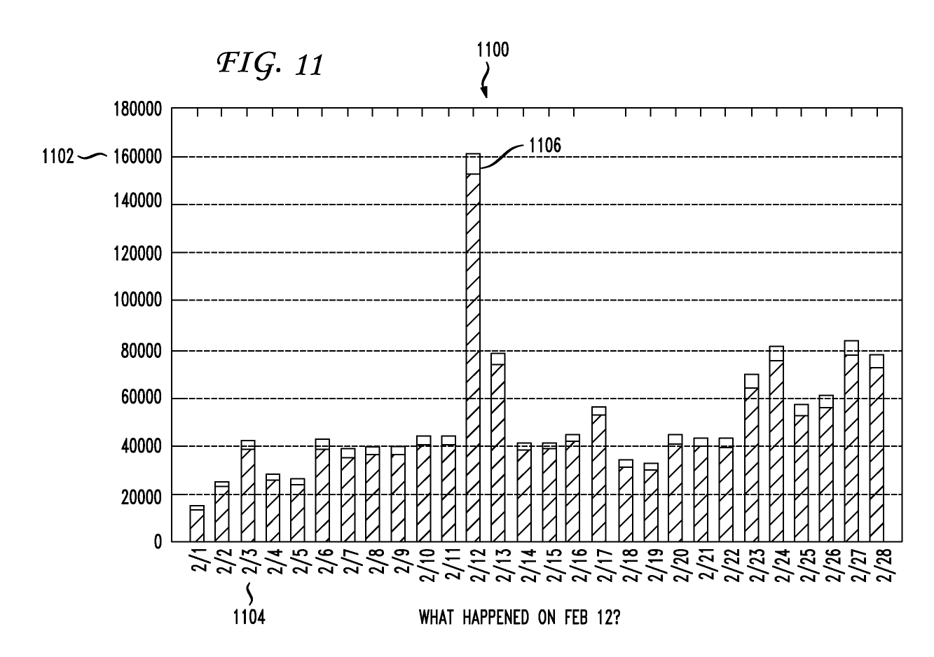

FIG. 10 illustrates an example of changes being tracked in a trouble-ticket creation system 1000. Once again, metavalues, in this case New Jersey which corresponds to the area of interest, are displayed 1002 and highlighted on a map 1004. The lexical item, “1503>804***” 1006 corresponds to a test call indicating a burst of test calls causing an increase in hangup rates. Keyword sequences show the test calls as trajectories 1008.

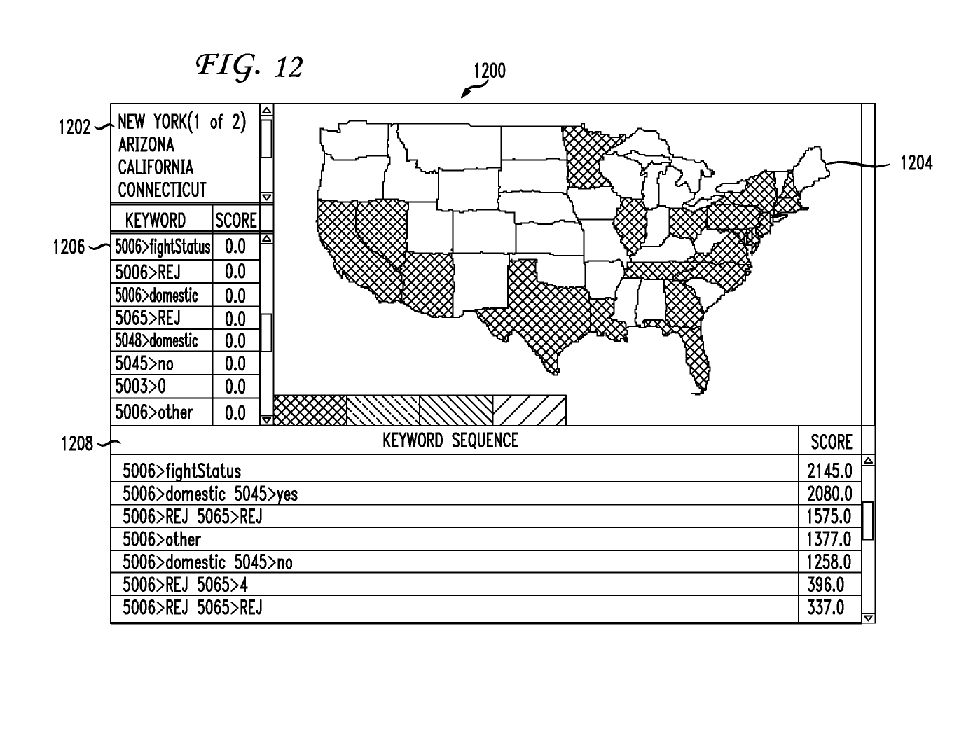

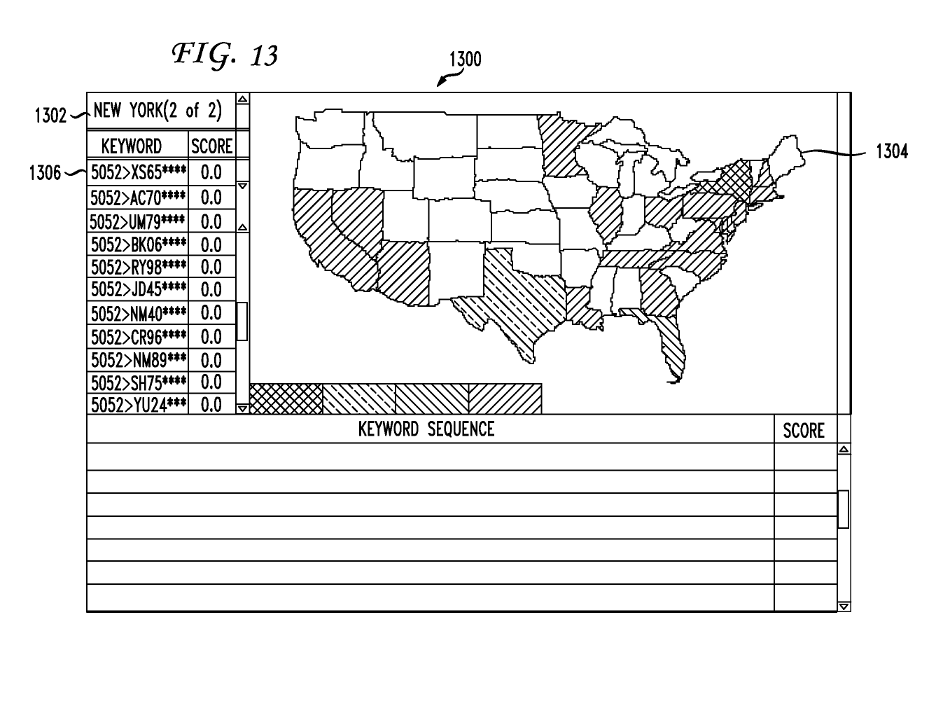

FIG. 11 and FIG. 12 illustrate change detection and coordination from data streams from an airline call-routing system. FIG. 11 illustrates the frequency of people calling to ask about their flight status 1100. Looking at the number of calls 1102 on a day-to-day basis 1104, a change in the frequency of the number of calls is detected on February 12 1106, when there was a blizzard in the Northeastern United States. FIG. 12 illustrates an example presentation of the detection and coordination to a user 1200. Once again, the areas of interest are listed 1202 and highlighted on the map with a certain color 1204. The “(1 of 2)” next to New York indicates that there are multiple change-events in New York that the user can view. The lexical items 1206 and the keyword sequences 1208 correspond to a large increase in flight status and domestic service requests due to the inclement weather in the northeast. Even though the blizzard was in the northeast, there were flights going all over the country so distant states such as Texas were also affected. FIG. 13 shows a contemporary change-event with the blizzard in the Northeastern United States 1300. The area of interest is New York 1302, which is shaded a different color for this separate change-event 1304. The keyword section lists lexical items 1306 corresponding to frequent-flyer numbers in separate states. The coordination algorithm separates this change-event from the main event even though both change-events were contemporary.

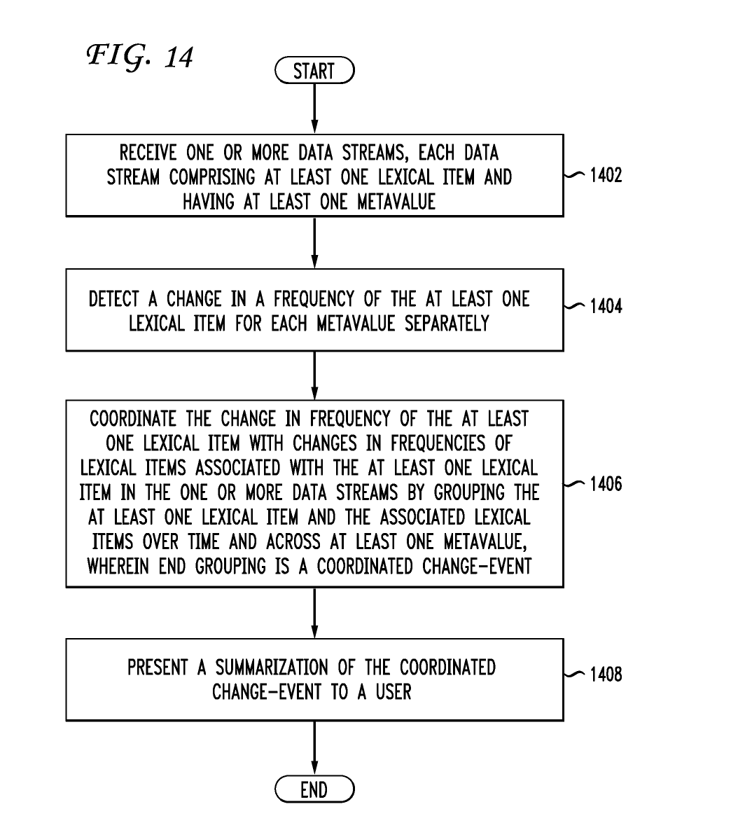

FIG. 14 illustrates a method of monitoring according to an aspect of the invention. The method comprises receiving one or more data streams, each data stream comprising at least one lexical item and having at least one metavalue 1402. Typically, multiple data streams serve as inputs although the system can monitor one data stream such as a television station, to track any important changes within that stream. The method also comprises detecting a change in a frequency of the at least one lexical item for each metavalue separately 1404. Next, the method comprises coordinating the change in frequency of the at least one lexical item with changes in frequencies of lexical items associated with the at least one lexical item by grouping the at least one lexical item and the associated lexical items over time and across at least one metavalue, wherein end grouping is a coordinated change-event 1406. Finally, the method comprises presenting a summarization of the coordinated change-event to a user 1408. Typically, the user will be an analyst trained to recognize the significance of the summarization. However, the summarization can be presented to any user, not necessarily an analyst. Furthermore, the summarization can be presented to multiple users.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, business environments, crime-prevention environments, or epidemic-prevention environments may involve tracking changes in which metavalues associated with data are taken into account. Accordingly, the appended claims and their legal equivalents should only define the invention, rather than any specific examples given.

I claim:

1. A method of detecting and coordinating changes in stratified data streams, the method comprising:
receiving one or more data streams, each data stream comprising at least one lexical item and having at least one metavalue;
detecting a change in a frequency of the at least one lexical item for each metavalue separately;
coordinating the change in frequency of the at least one lexical item with changes in frequencies of lexical items associated with the at least one lexical item by grouping the at least one lexical item and the associated lexical items over time and across at least one metavalue, wherein end grouping is a coordinated change-event; and
presenting a summarization of the coordinated change-event to a user.

2. The method of claim 1, wherein time intervals for change detection associated with the frequency of the at least one lexical item are selected automatically based on the one or more data streams.

3. The method of claim 1, wherein the summarization of the coordinated change-event is created by using frequent subsequences of lexical items.

4. The method of claim 1, wherein the data streams are text streams.

5. The method of claim 1, wherein detecting the change in the frequency is relative to at least one of: a total number of lexical items or a context of the at least one lexical item.

6. The method of claim 1, further comprising detecting steps, trends, and cycles in the frequency of the at least one lexical item.

7. The method of claim 1, further comprising assigning a significance to the change in frequency based on statistical significance and information content.

8. The method of claim 1, wherein presenting the summarization to a user has three dimensions: time, lexical vocabulary, and metavalues.

9. The method of claim 1, wherein the summarization is presented via a user interface with drill-down capability, and wherein the drill-down capability presents to the user data associated with time, lexical vocabulary, and metavalues.

10. The method of claim 1, wherein the at least one metavalue corresponds to a geographic location, service plans used, interaction history, or content information.

11. The method of claim 10, wherein the summarization is presented via a graphical user interface that has a map which visually displays the at least one metavlaue corresponding to a geographic location, service plan used, interaction history, or content information.

12. A system for detecting and coordinating changes in stratified data streams, the system comprising:
receiving one or more data streams, each data stream comprising at least one lexical item and having at least one metavalue;
detecting a change in a frequency of the at least one lexical item for each metavalue separately;
coordinating the change in frequency of the at least one lexical item with changes in frequencies of lexical items associated with the at least one lexical item by grouping the at least one lexical item and the associated lexical items over time and across at least one metavalue, wherein end grouping is a coordinated change-event; and
presenting a summarization of the coordinated change-event to a user.

13. The system of claim 12, wherein time intervals for change detection associated with the frequency of the at least one lexical item are selected automatically based on the one or more data streams.

14. The system of claim 12, wherein detecting the change in the frequency is relative to at least one of: a total number of lexical items or a context of the at least one lexical item.

15. The system of claim 12, further comprising detecting steps, trends, and cycles in the frequency of the at least one lexical item.

16. The system of claim 12, further comprising assigning a significance to the change in frequency based on statistical significance and information content.

17. The system of claim 12, wherein presenting the summarization to a user has three dimensions: time, lexical vocabulary, and metavalues.

18. The system of claim 12, wherein the at least one metavalue corresponds to a geographic location, service plans used, interaction history, or content information.

19. The system of claim 18, wherein the summarization is presented via a graphical user interface that has a map which visually displays the at least one metavlaue corresponding to a geographic location, service plan used, interaction history, or content information.

20. A computer readable medium storing a computer program having instructions for controlling a computing device to detect and coordinate changes in a stratified data stream, the instructions comprising
receiving one or more data streams, each data stream comprising at least one lexical item and having at least one metavalue;
detecting a change in a frequency of the at least one lexical item for each metavalue separately;
coordinating the change in frequency of the at least one lexical item with changes in frequencies of lexical items associated with the at least one lexical item by grouping the at least one lexical item and the associated lexical items over time and across at least one metavalue, wherein end grouping is a coordinated change-event; and
presenting a summarization of the coordinated change-event to a user.

21. The computer readable medium of claim 20, wherein time intervals for change detection associated with the frequency of the at least one lexical item are selected automatically based on the one or more data streams.

22. The computer readable medium of claim 20, wherein detecting the change in the frequency is relative to at least one of: a total number of lexical items or a context of the at least one lexical item.

23. The computer readable medium of claim 20, with a module configured to detect steps, trends, and cycles in the frequency of the at least one lexical item.

24. The computer readable medium of claim 20, with a module configured to assign a significance to the change in frequency based on statistical significance and information content.

25. The computer readable medium of claim 20, wherein the at least one metavalue corresponds to a geographic location, service plans used, interaction history, or content information.

26. The computer readable medium of claim 25, wherein the summarization is presented via a graphical user interface that has a map which visually displays the at least one metavlaue corresponding to a geographic location, service plan used, interaction history, or content information.
